(19) United States
(12) Patent Application Publication
(10) Pub. No.: US 2015/0188888 A1
(43) Pub. Date: Jul. 2, 2015

(54) VIRTUAL PRIVATE NETWORK GATEWAY AND METHOD OF SECURE COMMUNICATION THEREFOR

(71) Applicant: Electronics and Telecommunications Research Institute, Daejeon (KR)

(72) Inventors: Yoo Hwa KANG, Daejeon (KR); Hea Sook PARK, Daejeon (KR); Soon Seok LEE, Daejeon (KR)

(21) Appl. No.: 14/585,692

(22) Filed: Dec. 30, 2014

(30) Foreign Application Priority Data
Dec. 31, 2013 (KR) 10-2013-0169312

(51) Int. Cl. H04L 29/06

(52) U.S. Cl. CPC H04L 63/0272

(57) ABSTRACT

A VPN (Virtual Private Network) gateway virtualizes a logical gateway corresponding to a VPC (Virtual Private Cloud) group of a connected user terminal, based on a virtual address of the user terminal, and logically connects the logical gateway to the database corresponding to the VPC group to provide VPC service to the user terminal.

### CROSS-REFERENCE TO RELATED APPLICATION

This application claims priority to and the benefit of Korean Patent Application No. 10-2013-0169312 filed in the Korean Intellectual Property Office on Dec. 31, 2013, the entire contents of which are incorporated herein by reference.

### BACKGROUND OF THE INVENTION

(a) Field of the Invention

The present invention relates to a virtual private network gateway and a method of secure communication therefor, and more particularly, to a virtual private network gateway for providing a secure Virtual Private Cloud service and a method of secure communication therefor.

(b) Description of the Related Art

A Virtual Private Cloud (VPC) is a private cloud that exists within a shared or common cloud.

Amazon Web Services delivers cloud services by VPC, and provides Internet Protocol Security Virtual Private Network (IPSec VPN) connections for data transfer. Google Application Engine delivers services similar to VPC with Google's Secure Data Connector.

In the U.S., the Department of Defense is planning to develop the Black Core Network technology for the advancement of the Defense Internet by 2020. The Black Core Network technology presupposes the existence of users in a closed network, is unfit for general public Internet services because HAIPE (High Assurance Internet Protocol Encryption) protocol applies to all communications, and is unavailable in countries other than the U.S. until the disclosure of HAIPE protocol since HAIPE protocol has not been disclosed yet. Moreover, services through a public communication network are limited because black core network connections are based on a private network.

Although Nebula and XIA (eXpressive Internet Architecture) technologies, which belong to the field of Future Internet research, suggest a new routing system based on a new, reliable identifier (ID) system, these technologies are innovative or long-term solutions as they offer ways to build a completely new network.

Cisco's Locator/Identifier Separation Protocol (LISP), which is a technology of separating a user identifier (ID) and a locator for routing purposes, is a way of solving the problem of address depletion and separating the locator and identifier of an address, and LISP is being standardized by IETF.

Although Amazon and Verizon have been developing a VPC/VCN (Virtual Cloud Networking) technology of concealing private cloud resources, this model is not suitable for mobile cloud environments and has problems with the provision of mobile services.

An ISP (Internet Service Provider) network requires a secure virtual private cloud service, and also requires a network service model which overcomes the problem of address depletion, caused by the use of IPs, and the limitations of mobility services, and is easily applicable to the existing networks.

### SUMMARY OF THE INVENTION

The present invention has been made in an effort to provide a virtual private network gateway which solves the problem of address depletion caused by the use of IPs and provides a secure virtual cloud service, and a method of secure communication therefor.

An exemplary embodiment of the present invention provides a VPN (Virtual Private Network) gateway for providing a VPC (Virtual Private Cloud) service. The VPN gateway includes a virtual gateway generator and a network connector. The virtual gateway generator generates a logical gateway corresponding to the VPC group of a connected user terminal, based on a virtual address of the user terminal. The network connector logically connects the logical gateway to the database corresponding to a VPC group to provide the VPC service.

The virtual address may include an identifier of the VPC group and a private address assigned to the user terminal.

The Virtual Private Network gateway may further include a routing processor. The routing processor performs routing based on the virtual address of the connected user terminal.

The VPC group may be classified according to the type of network.

Another embodiment of the present invention provides a method of secure communication which provides a VPC (Virtual Private Cloud) service through a VPN (Virtual Private Network) gateway. The method of secure communication for a VPN gateway may include: receiving a virtual address of a sending terminal and a virtual address of a receiving terminal from the sending terminal; and transmitting data to the virtual address of the receiving terminal, wherein the virtual address of the receiving terminal may include an identifier of a VPC group of the receiving terminal and a private IP address of the receiving terminal, and the virtual address of the sending terminal may include the identifier of the VPC group of the sending terminal and the private IP address of the sending terminal.

The receiving may include generating a logical gateway corresponding to the VPC group of the sending terminal, based on a virtual address of the user terminal.

The transmitting may include passing data to the database corresponding to the VPC group of the sending terminal based on the virtual address of the sending terminal.

### BRIEF DESCRIPTION OF THE DRAWINGS

FIG. 1 is a network configuration diagram for a virtual cloud service providing system according to an exemplary embodiment of the present invention.

FIG. 2 is a view schematically showing a VPN gateway according to an exemplary embodiment of the present invention.

FIG. 3 is a view showing an example of a commercially available service network.

FIG. 4 is a view showing an example of a service network that provides a virtual cloud service through a VPN gateway according to an exemplary embodiment of the present invention.

FIG. 5 is a view showing a method of secure communication according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Now, a virtual private network gateway and a method of secure communication therefor according to an exemplary embodiment of the present invention will be described with reference to the accompanying drawings.

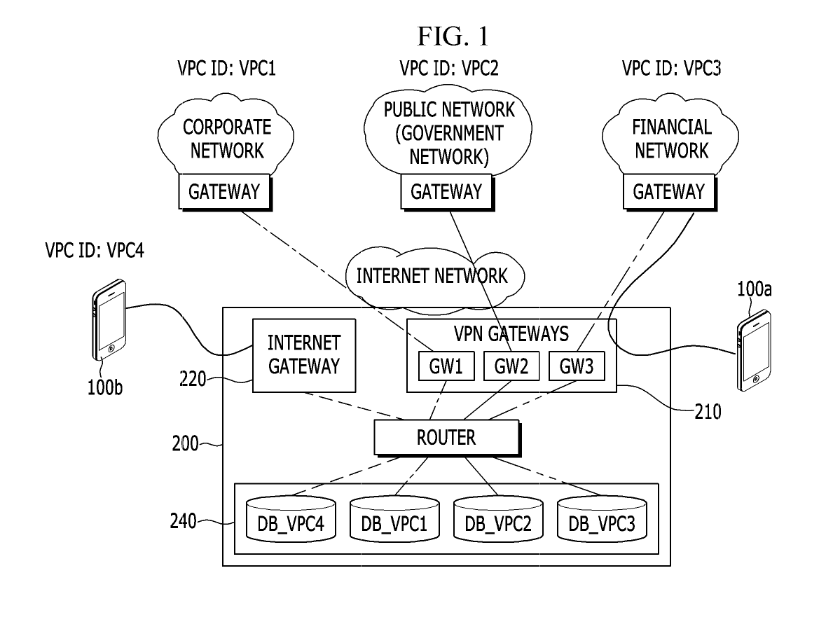

FIG. 1 is a network configuration diagram for a virtual cloud service providing system according to an exemplary embodiment of the present invention.

Referring to FIG. 1, user terminals 100a and 100b of each Virtual Private Cloud (VPC) group connect to a cloud center 200 and receive VPC service.

The user terminal 100b is a general Internet user terminal, and is connected to the cloud center 200 via an Internet gateway 220 and receives general VPC service.

The user terminal 100a is a terminal authenticated on an individual network, which is a Virtual Private Network (VPN). The user terminal 100a is connected to the cloud center 200 via a VPN gateway 210 and receives VPC service for secure communication. Examples of VPN include a corporate network, a public network, and a financial network, and each of these VPNs may include a gateway.

Also, the user terminal 100a can be connected via the VPN gateway 210 to an individual network (e.g., financial network) on which the user terminal 100a is authenticated.

The user terminals 100a and 100b belong to the corresponding VPC group. The user terminal 100a can receive VPC service through a virtual address, which is a combination of the identifier ID of the corresponding VPC group and a private address assigned to the user terminal 100a, and the user terminals 100a and 100b can receive VPC service through a public IP address. The private address may be various addresses, such as IPX (Internet Packet Exchange) and sensor network identifier, for which IP routing is not enabled. In an All-IP network, an IP address serves as both an Identifier (ID) for identifying the host and a Locator for routing purposes. Accordingly, the problem of IP address depletion is emerging as the number of user terminals gradually increases. However, a virtual address according to an exemplary embodiment of the present invention consists of a combination of the ID of a VPC group and a private address. Therefore, the same private address can be used within the same VPC group. This solves the problem of IP address depletion, which can occur with the use of IP addresses.

VPC groups can be classified according to the type of individual network and set criteria. Each VPC group can be classified into one or more security groups depending on their internal characteristics. For example, an individual network is a network which is protected externally through its own secure communication, and the types of individual networks include a corporate network, a public network (government network), a financial network, and so on, and a corporate network, a public network, a government network, and an individual can be classified as respective VPC groups. Each VPC group is assigned identifiers (VPC1, VPC2, VPC3, and VPC4) for identifying each VPC group. In addition, each of these individual networks has a gateway, and they are protected on their own since the gateway is in charge of secure communication for the internal network.

The cloud center 200 provides VPC service to the connected user terminals 100a and 100b. The cloud center 200 stores data from the user terminals 100a and 100b in a database 240, based on a virtual address of the connected user terminal 100a or an authorized IP address of the user terminal 100b, and upon receiving a data request, provides the corresponding data to the user terminals 100a and 10b based on the virtual address of the connected user terminal 100a and the authorized IP address of the user terminal 100a.

The cloud center 200 can include a VPN gateway 210, an Internet gateway 220, a router 230, and a database 240.

In the cloud center 200, the VPN gateway 210 performs secure communication for the cloud center 200, authenticates the connected user terminal 100a, and provides virtualized logical network connectivity to the authenticated user terminal 100a. The VPN gateway 210 generates logical gateways (GW1, GW2, GW3, . . . ) depending on the number of VPC groups, and each logical gateway (GW1, GW2, GW3, . . . ) is connected to DBs (DB_VPC1, DB_VPC2, and DB_VPC3) respectively corresponding to the VPC groups. The VPN gateway 210 stores data from the user terminal 100a in the logically connected DB (DB_VPC3) based on the virtual address of the user terminal 100a that has connected to the cloud center 200. Moreover, the VPN gateway 210 performs the function for identifying individual networks, and interfaces the connected user terminal 100a to the corresponding individual network (e.g., financial network).

The Internet gateway 220 provides logical network connectivity to the user terminal 100b that has connected to the cloud center 200. That is, the Internet gateway 220 can store data from the connected user terminal 100b in the logically connected private DB (DB_VPC4) through the router 230.

The router 230 connects the connected user terminals 100a and 100b with the DBs (DB_VPC1, DB_VPC2, and DB_VPC3) of the database 240.

The database 240 stores data from the user terminals 100a and 100b. The database 240 includes the DBs (DB_VPC1, DB_VPC2, and DB_VPC3) respectively corresponding to the VPC groups, and data from the VPC groups (VPC1, VPC2, VPC3, and VPC4) can be stored in the DBs (DB_VPC1, DB_VPC2, and DB_VPC3) of the VPC groups.

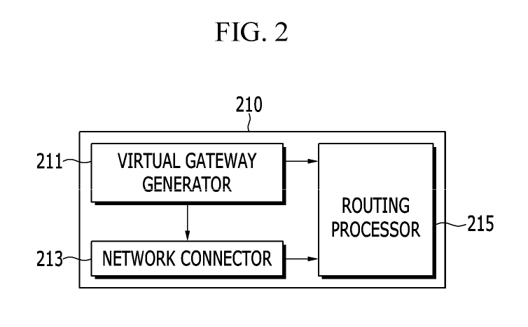

FIG. 2 is a view schematically showing a VPN gateway according to an exemplary embodiment of the present invention.

Referring to FIG. 2, the VPN gateway 210 includes a virtual gateway generator 211, a network connector 213, and a routing processor 215.

If the identifier of the VPC group of the connected user terminal 100a is VPC3, the virtual gateway generator 211 checks the identifier VPC3 of the VPC group of the user terminal 100a from the virtual address of the user terminal 100a, and checks whether the logical gateway GW3 corresponding to the VPC group with the identifier VPC3 exists. If the logical gateway does not exist, the virtual gateway generator 211 virtually generates the gateway GW3 corresponding to the identifier VPC3 of the VPC group.

The network connector 213 passes information on the identifier VPC3 of the VPC group to the router 230 and provides a logical network connection to the DB (DB_VPC3) of the identifier VPC3 of the VPC group. This enables the delivery of the VPC service.

The routing processor 215 performs routing based on a virtual address. Upon receiving data from the connected user terminal 100a, the routing processor 215 transmits the data from the user terminal 100a based on the virtual address corresponding to the destination address of the data. If the destination address corresponds to the cloud center 200, the routing processor 215 can pass the data from the user terminal 100 to the router 230 through the logical gateway GW3 corresponding to the identifier VPC3 of the VPC group.

Also, the routing processor 215 transmits data from the cloud center 200 to the user terminal 100a based on the virtual address of the user terminal 100a.

In this way, the VPN gateway 210 provides a logically protected network connection, such that the user terminal 100a can receive protected communication service through the VPN gateway 210.

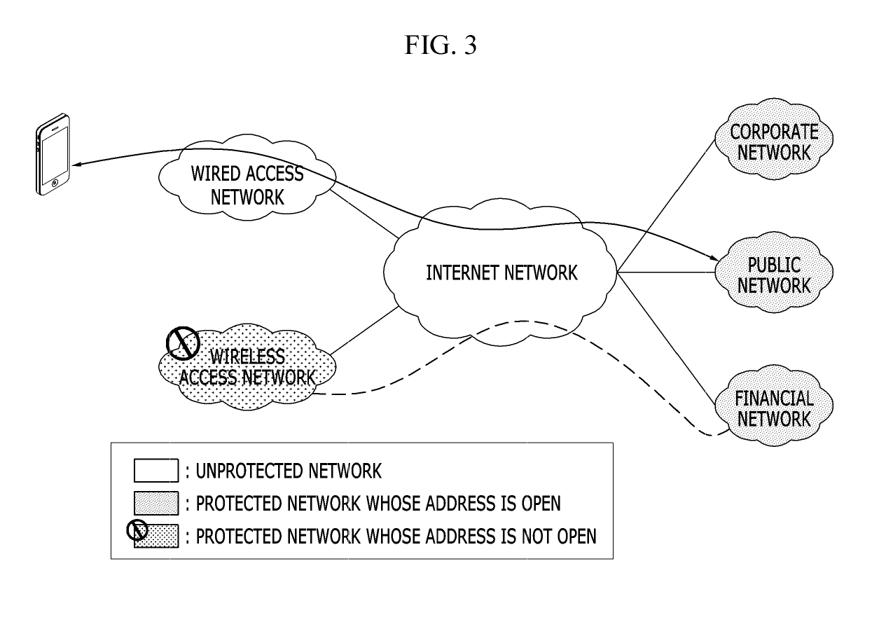

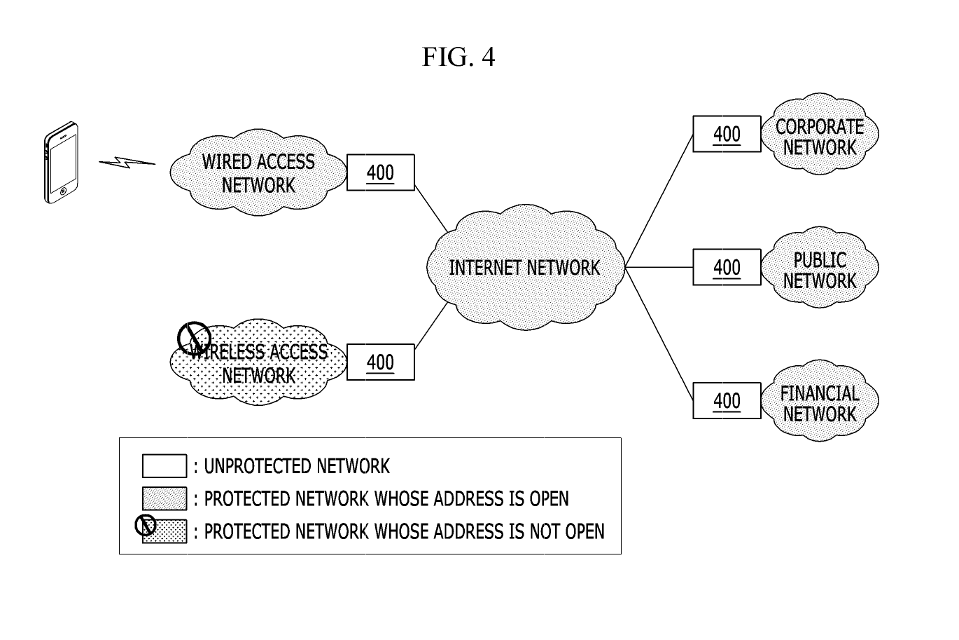

FIG. 3 is a view showing an example of a commercially available service network, and FIG. 4 is a view showing an example of a service network that provides a virtual cloud service through a VPN gateway according to an exemplary embodiment of the present invention.

As shown in FIG. 3, in general, an Internet network and a general wired access network operate as unprotected networks, and a wireless access network is used as a protected network because it uses a private IP address, but has the problem of private IP address extension. Individual networks, such as a corporate network or public network which focuses on security, are configured as separate protected networks by physical network separation or through a cloud service. When the individual networks use an internet network, the use of a cloud service is not considered due to security.

As shown in FIG. 4, however, if a gateway 400 functioning as the above-explained VPN gateway 210 is situated in wired and wireless access networks and individual networks, the wire and wireless networks, the private networks, and the Internet network can all be configured as protected networks. Moreover, by using private IP addresses in the individual networks, as well as the wired and wireless networks, only virtual addresses can be left open and actual private IP addresses can be protected.

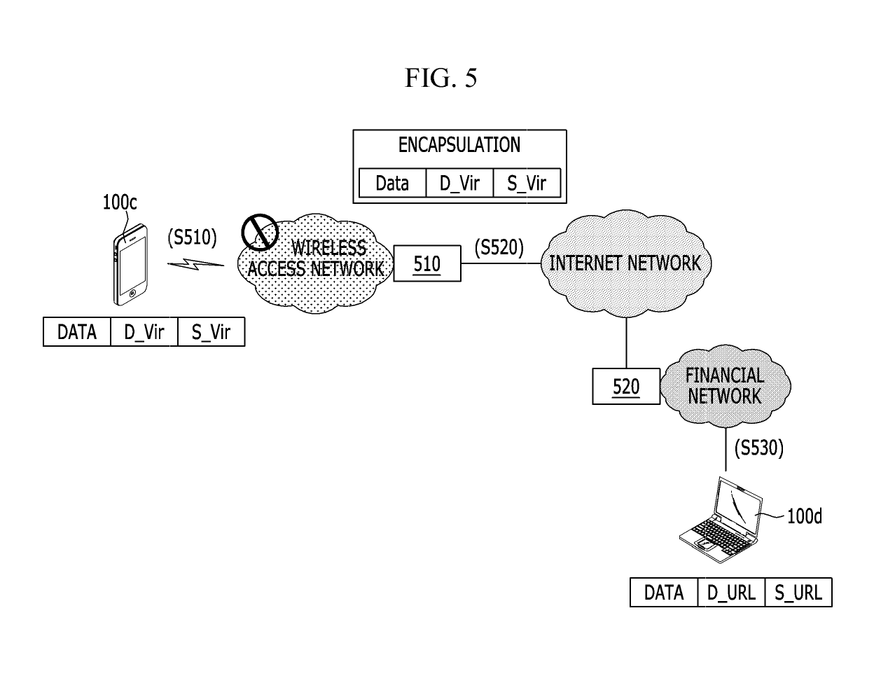

FIG. 5 is a view showing a method of secure communication according to an exemplary embodiment of the present invention.

FIG. 5 illustrates signaling for virtual address-based secure communication between a VPN gateway 510 of a wireless access network and a gateway 520 of a private network for convenience.

Referring to FIG. 5, if a user terminal 100c located in a wireless access network wants to use a financial network, the user terminal 100c sends data by using a virtual address of the financial network as the destination address D_Vir and a virtual address of the user terminal 100c as the source address S_Vir (S510). The virtual address of the financial network is an address that corresponds to a combination of the VPC ID of the financial network and the private IP address of a user terminal 100d.

The gateway 510 of the wireless access network processes data received from the user terminal 100c according to the data transmission and reception standard set for the Internet network, and then transmits it to the virtual address of the financial network (S520). For example, the gateway 510 encapsulates data which uses the virtual address of the financial network as the destination address D_Vir and the virtual address of the user terminal 100c as the source address S_Vir, and then transmits it to the virtual address of the financial network through a configured tunnel.

The gateway 520 of the financial network decapsulates the encapsulated data, and transmits the data to the user terminal 100d based on the virtual address corresponding to the destination address D_Vir of the restored data (S530).

The user terminal 100d can receive the data from the user terminal 100c.

According to an embodiment of the present invention, the use of virtual addresses rather than actual addresses on service platforms, national/public infrastructures, and corporate IT structures which require protection allows complete protection from hacking and DDoS attacks and ensures mobile VoIP services and highly reliable mobile communication services, and guaranteed bandwidth and low-cost leased lines can be provided by constructing a virtual network without physical network separation.

Furthermore, according to an embodiment of the present invention, a VPC identifier is assigned to each company and data is transmitted through a combination of the VPC identifier and a private IP address, whereas corporate cloud services provided by an ISP network provider are provided to companies to which private network addresses are exclusively assigned. Hence, each company can make free use of the full private IP address, thereby overcoming the problem of IP address extension.

Furthermore, data transfer using a logical network connection over an Internet network can be performed separately from signaling for secure communication by which virtual address-based routing is performed. Therefore, extended signaling makes it easy to deliver services regardless of data transfer, even with the addition of new services such as mobility.

An exemplary embodiment of the present invention may not only be embodied through the above-described apparatus and method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A VPN (Virtual Private Network) gateway for providing a VPC (Virtual Private Cloud) service, the VPN gateway comprising:
a virtual gateway generator generating a logical gateway corresponding to a VPC group of a connected user terminal, based on a virtual address of the user terminal; and
a network connector logically connecting the logical gateway to the database corresponding to the VPC group to provide the VPC service.

2. The VPN gateway of claim 2, wherein the virtual address comprises an identifier of the VPC group and a private address assigned to the user terminal.

3. The VPN gateway of claim 1, further comprising a routing processor performing routing based on the virtual address of the connected user terminal.

4. The VPN gateway of claim 1, wherein the VPC group is classified according to the type of network.

5. A method of secure communication which provides a VPC (Virtual Private Cloud) service through a VPN (Virtual Private Network) gateway, the method comprising:
receiving a virtual address of a sending terminal and a virtual address of a receiving terminal from the sending terminal; and
transmitting data to the virtual address of the receiving terminal,
wherein the virtual address of the receiving terminal comprises an identifier of a VPC group of the receiving terminal and a private IP address of the receiving terminal, and the virtual address of the sending terminal comprises the identifier of the VPC group of the sending terminal and the private IP address of the sending terminal.

6. The method of claim 5, wherein the receiving comprises generating a logical gateway corresponding to the VPC group of the sending terminal, based on a virtual address of the user terminal.

7. The method of claim 5, wherein the transmitting comprises passing data to the database corresponding to the VPC group of the sending terminal based on the virtual address of the sending terminal.

8. The method of claim 5, wherein the VPC group is classified according to the type of network.
